(19) United States
(12) Patent Application Publication
(10) Pub. No.: US 2002/0131729 A1
(43) Pub. Date: Sep. 19, 2002

(54) Method and system for automated dynamic fiber optic alignment and assembly

(76) Inventor: Leo M. Higgins III, Austin, TX (US)

Correspondence Address: LAURA M. SLENZAK, SIEMENS CORPORATION, 186 WOOD AVENUE SOUTH, ISELIN, NJ, 08830, US

(21) Appl. No.: 10/077,725

(22) Filed: Feb. 15, 2002

Related U.S. Application Data
(60) Provisional application No. 60/269,421, filed on Feb. 16, 2001.

(51) Int. Cl. G02B 6/42

(52) U.S. Cl. 385/91; 385/90

(57) ABSTRACT

A system and method for the automated alignment and assembly of a first end of an optical fiber to an optical module includes a second optical module generally adjacent a second end of the optical fiber and connected to a computer. The computer monitors the optical transmission between the two modules through the optical fiber and controls movement of the first end of the optical fiber to optimize the position of the first end of the optical fiber relative to the first optical module.

This application claims priority to U.S. Provisional Application Serial No. 60/269,421, filed Feb. 16, 2001.

### BACKGROUND OF THE INVENTION

The present invention relates to a method and system for aligning and assembling an optical fiber to an optical module, such as a laser transmitter module or laser receiver module.

Optical modules (laser transmitter modules or laser receiver modules), such as those used for telecommunication, generally include a laser source (laser diode) or a laser detector (photodiode) mounted on a substrate, or series of substrates, along with one or more module components. One end of an optical fiber is bonded to the module, or a component in the module, such as a substrate, in an optically aligned position with the laser source or detector (or lens of the source or detector). The optical module is sold and shipped as a unit with approximately one to five meters of the optical fiber extending from the module to permit subsequent connection of the optical fiber to other components or other fibers using known techniques.

However, connection of the optical fiber to the optical module, in particular, the alignment of the optical fiber with the laser or a detector, is difficult and time consuming. For assembly to a laser transmitter in the previously known technique, for example, micro-manipulators may be operated by hand to move one end of the optical fiber into proper alignment with the laser. The laser is powered during the alignment process, while the opposite end of the optical fiber is aligned with a light intensity meter to measure the intensity of the laser beam passing through the optical fiber. The light intensity meter will reach its maximum value when the alignment of the first end of the optical fiber is properly aligned with the laser transmitter. The first end of the optical fiber is then connected to the optical module at that location using known techniques.

### SUMMARY OF THE INVENTION

In the present invention the automated optical fiber alignment and assembly system provides a sequence of processes used to bond the end of an optical fiber in precise alignment with a laser diode light source, or to a photodiode light detector.

One embodiment of the present invention includes the steps of loading trays of modules along with a spool of optical fiber into the system of this invention. The fiber is threaded through guides into a desired location. A pick and place head of system removes a laser module from the input area, and places it in a receptacle on a load board. Module inputs and outputs are electrically connected to the load board through a precision socket. The load board is electrically connected to test circuitry to power up the module. Fiber from the fiber spool unreels such that the fiber end extends into the fiber indexer. The fiber end is then indexed to the cleaning station where the polymer buffer is removed from fiber end and the surface of the fiber end is cleaned. A fiber cutter cuts the fiber so as to present a pristine fiber end. The face of the fiber end is then cleaned. At this step, the fiber end may also be shaped. The sixth process is the indexing of the fiber end through a fiber coiling mechanism where the desired length of fiber is coiled and bound to prevent uncoiling. The fiber end is then indexed into the fiber alignment module.

The fiber end is then aligned with the laser diode. The fiber end is bonded to the module while maintaining precise alignment with the laser diode. The organic buffer coating on the fiber is then removed on a portion of the fiber positioned at the cleaning station. The fiber is then cut, leaving the coiled fiber pig-tail connected to the laser module in precise alignment with the laser diode. The pick and place head in the system moves the fiber-assembled module to an output tray.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic representation of the alignment and assembly system of the present invention;

Figure 1A is a schematic representation of the tool head;

FIG. 2, is a perspective view of an optical fiber;

FIG. 3 is a schematic view of an alignment/indexing mechanism;

FIG. 4 is a schematic view of the spool feed assembly;

FIG. 5 is a block diagram of the method of assembly;

FIG. 6A is a schematic view of a fiber cleaning mechanism;

FIG. 6B is a schematic view of a fiber cutting mechanism;

FIG. 6C is a schematic view of a fiber face cleaning mechanism;

FIG. 6D is a schematic view of a coiling mechanism; and

FIG. 6E is a schematic view of a two-image vision system to assist in fiber alignment.

### DETAILED DESCRIPTION OF A PREFERRED EMBODIMENT

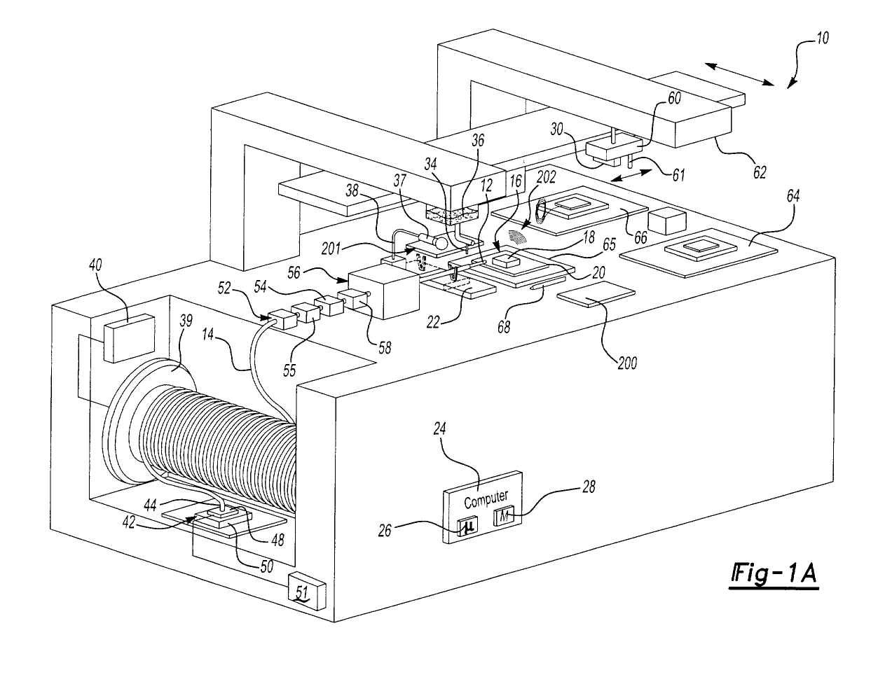

FIG. 1 illustrates the automated optical fiber alignment and assembly system 10 of the present invention for aligning and assembling a first end 12 of an optical fiber 14 to an optical module 16. The present invention can be used to align and connect the optical fiber 14 to a laser transmitter module or a laser receiver module; however, for clarity, the invention will first be described where the optical module 16 is a laser transmitter module which includes a laser diode 18 mounted on a substrate, or housing 20.

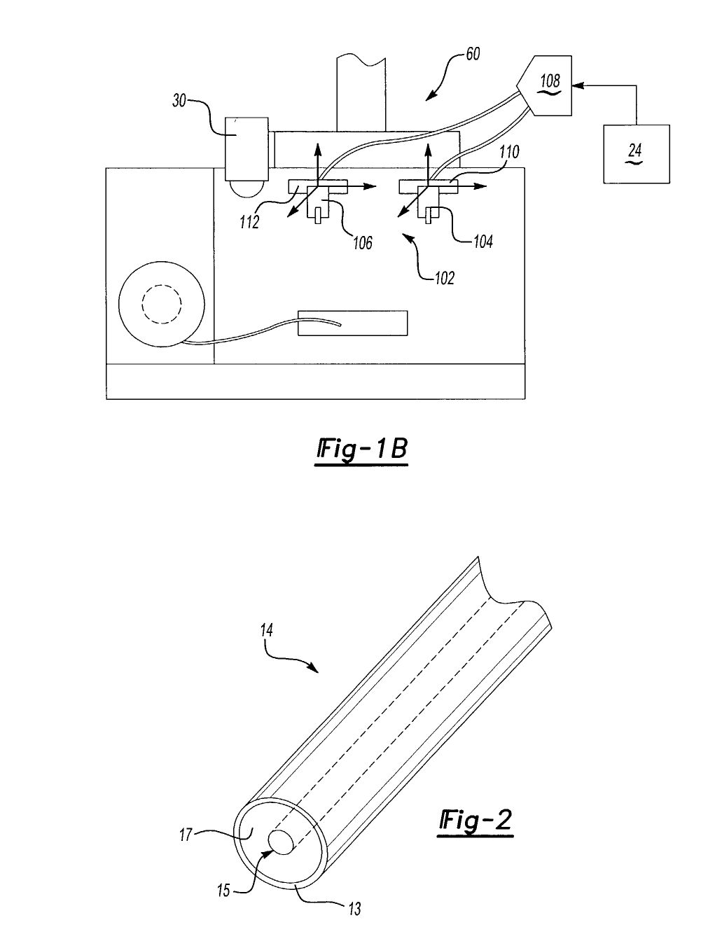

The fiber alignment module 22 is generally a robotic mechanism, such as a piezo-electric nano-motor (such as sold by Aerotech, Klocke Nanotecnik, Newport Instruments, or similar), which grasps the optical fiber 14 with an end effector at a predetermined distance from the first fiber end 12. For the highest performance modules, the fiber alignment movement module 22 preferably has 50 nanometer strokes or less, and more preferably 20 nanometer strokes or less, over a distance of one centimeter. The fiber alignment module 22 will have rotational accuracy and precision necessary to optimize alignment. The rotational accuracy will typically be within 1-10 arc secs. The movement of alignment system 22 is controlled by a computer 24, generally comprising a microprocessor 26 and memory 28. The computer 24 is suitably programmed to perform the functions described herein (for clarity, connections to the computer 24 are not shown). The optical fiber 14 is provided on a fiber spool 39. The optical fiber 14 includes a fiber core 15 which is contained within a cladding layer 17 which is surrounded by an organic polymer buffer coating 13 (FIG. 2).

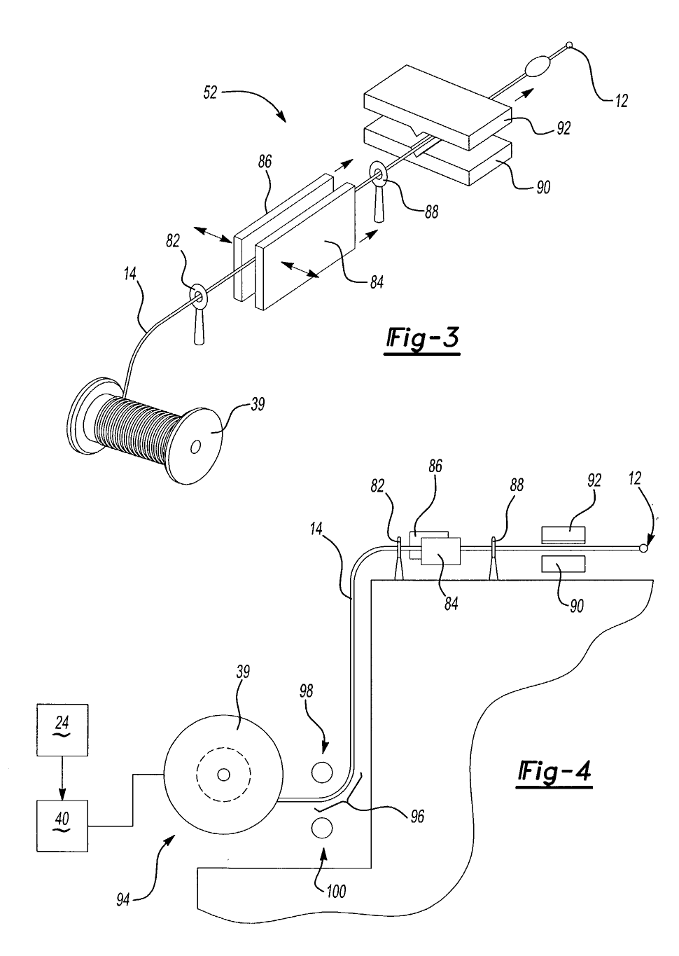

Referring to FIGS. 1 and 3, the fiber 14 is threaded through a desired set of alignment guides and through the fiber indexer 52 in the system set up. One method of providing alignment guides may be with the use of alignment eyelets. In this configuration first fiber end 12 is threaded through the fiber indexer 52 subsystem. This fiber indexer 52 subsystem may be comprised of a first alignment eyelet 82, indexer gripper plates 84 and 86, second alignment eyelet 88, fixed coarse alignment plate 90, and pinch plate 92. In this one possible configuration of a preferred embodiment, the first fiber end 12 is threaded through first alignment eyelet 82, in between indexer gripper plates 84 and 86, through second alignment eyelet 88, and in between pinch plate 92 and fixed coarse alignment plate 90.

Fiber 14 is unreeled from fiber spool 39 through a pulling action from a computer 24 controlled drive, which is a component of the fiber indexer 52. Fiber indexer 52 may also advance the fiber 14 with less fiber stress through synchronization with fiber spool 39 unreeling action from fiber spool motor 40. This action moves the first end 12 in a plane perpendicular to the optical fiber 14 in order to maintain coarse alignment with laser diode 18 (or lens for the laser diode 18) in the module 16 mounted on load board 68 in assembly area 65.

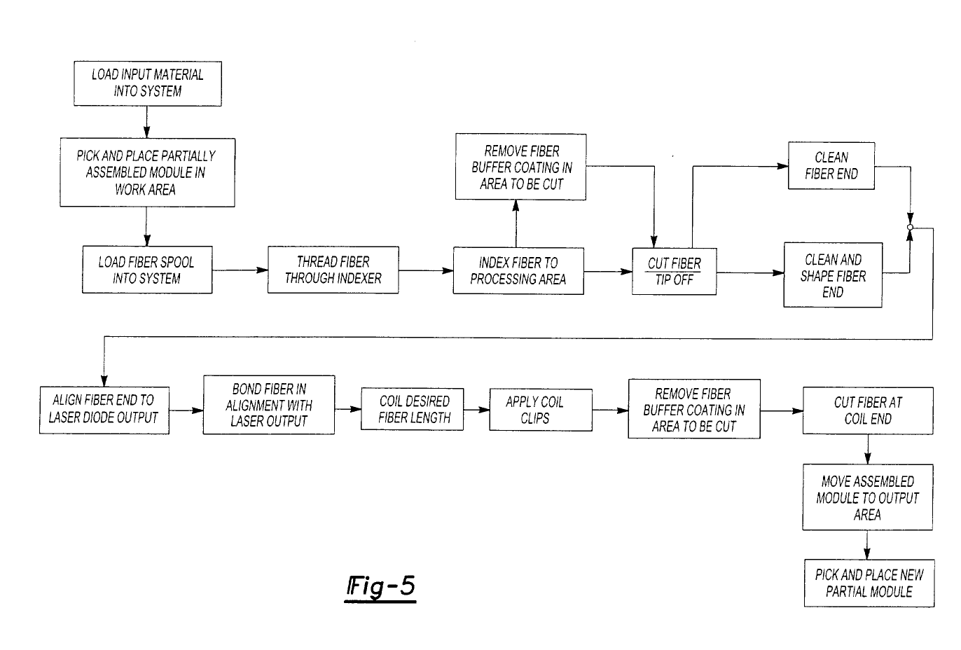

Referring to FIGS. 1 and 4, in order to further minimize tensile stress on the fiber 14 it may be desired to add a slack loop system 94 to the unreeling area. This slack loop system 94 comprises a length 96 of relatively tension-free fiber, an upper position sensor 98, and a lower position sensor 100. During operation the computer 24 will instruct the motor 40 to unreel fiber 14 from fiber spool 39 until the slack length of fiber 96 is sensed by lower position sensor 100. At this point, feedback from lower position sensor 100 will instruct the motor 40 to stop unreeling fiber spool 39. After fiber indexer 52 has indexed a sufficient length of fiber 14 through the system, the length of slack loop 96 will be reduced such that a region of fiber in slack loop 96 will be sensed by upper position sensor 98. This will occur without causing unreeling from the spool. At this point feedback from upper position sensor 98 will signal the slack loop system 94 to unreel fiber 14 from spool 39, thus lengthening slack loop 96 until the length of fiber 14 is once again detected by the lower position sensor 100. At this point the reeling is instructed to stop, and the process continues during each cycle.

Referring to FIG. 3, during fiber indexing, a sequence of actions takes place within fiber indexer 52. First, pinch plate 92 is raised above fixed coarse alignment plate 90, removing any gripping force on the length of fiber 14 which resides above coarse alignment plate 92. Second, indexer gripper plates 84,86 are actuated to move towards each other to establish a gripping force on the length of fiber 14, which resides therebetween. The indexer gripper plates 84,86 then move toward the second alignment eyelet 88, thus advancing a length of fiber 14 towards the first optical module 16 (FIG. 1). The pinch plate 92 mechanically grips a length of fiber 14 between the pinch plate 92 and fixed coarse alignment plate 90. The indexer gripper plates 84,86 move apart, releasing the length of fiber 14. The indexer gripper plates 84,86 move back towards the first alignment eyelet 82.

The length of the indexing motion of indexer gripper plates 84,86 may be programmably variable, and the motion controlled to accurately and repeatably control the position of first fiber end 12 to the fiber alignment module 22 within approximately 15 micrometers of the desired target. The position of the fiber end 12 to the laser diode 18, or the lens (not shown) for laser diode 18, is controlled to within a desired standard deviation which may typically be less than 0.05 micrometers, or 50 nanometers.

It is readily anticipated that numerous other methods and mechanisms may be used to minimize tensile stress on the fiber 14, and to very accurately index the fiber 14 through the system 10, and while these methods and mechanisms are not described herein, it is the intent of this invention to include such readily anticipated methods and mechanisms. These other methods and mechanisms may include, but are not limited to driving the fiber unreeling mechanism in precise synchronization with the fiber indexing motion without the use of a slack loop system herein described, or simply pulling the fiber 14 from the reel 39 with an acceptable tensile stress. These other methods and mechanisms may also include, but are not limited to alternative means to guide, grip and index the fiber 14, such as the use of a small precision conveyor belt drive with mechanical or vacuum actuated grippers with fiber guidance provided by grooved V-blocks instead of eyelets.

Referring to FIG. 1, the system 10 further includes a second optical module 42 mounted adjacent the second end 44 of the optical fiber 14. In this first example, the second optical module 42 preferably comprises a laser receiver 48 mounted on a load board 50. The second end 44 of the optical fiber 14 is previously aligned with the receiver 48 (or a lens for receiver 48) and secured to the second optical module 42. Load board 50 is electrically connected to a tester 51 which provides power to laser receiver module 48, and monitors the output of the photodiode which is a function of the varying power coupled from fiber 14 into the photodiode. The tester 51 is interconnected to the computer 24, and provides the computer 24 with photodiode data on the coupled power. The computer 24 uses this feedback data to interact with the motion control program for the alignment module 22, and to then modulate the alignment module motion to optimize fiber end 12 alignment with laser diode 18 output in the shortest time.

The system 10 may further include a vision system camera 30, such as a CCD or CMOS device, which is mounted on a tooling head 60 and moved by gantry assembly 62. Response from pattern recognition programs used by the camera 30 system is used as input for the gantry 62 motion control system to assure precise gantry tool position prior to tool actuation.

Tools mounted on the gantry tooling head 60 may include a liquid polymer system dispensing head, a pick and place end effecter which uses vacuum or mechanical action to pick and place components, and a welding laser output.

To use a laser welding operation to bond the fiber in place in precise alignment, the pick and place head will place a first micro-fixture on the fiber 14 several millimeters from the fiber end 12. In some cases it will be necessary to place and weld a second micro-fixture on the substrate 20 to which the fiber 14 is to be bonded prior to final fiber end 12 indexing and alignment using alignment module 22. This second micro-fixture could also be attached to the substrate during a prior module assembly operation where this lower, or second micro-fixture could have been placed and welded into position to receive the first fiber end 12.

The welding laser module can be mounted to the tooling head 60, or elsewhere within system 10, with the laser beam being delivered with flexible fiber optics or by other means and with the output of the laser fiber optics being mechanically attached to the gantry tooling head 60. Since welding the fiber in place generally requires more than one weld, it will generally be necessary for the gantry 60 to move the tooling headmounted mounted laser source to two or more laser welding locations. Since the welding employed in this assembly operation is micro-spot welding, it may be required to form two welds simultaneously, so as to best assure the maintenance of the precision alignment of fiber end 12 achieved by the nano-motor positioning of the alignment module 22. Therefore, system 10 would provide for optional configurations for the welding laser system.

Referring to Figure 1a, an embodiment of the welding laser system 102 is schematically shown attached to the tooling head 60 and includes two independent lasers 104,106. The laser energy is generated at a power source 108 and transmitted to the laser 104, 106. The power source 108 may include a single laser diode with the power being optically split into the two independent laser sources. Alternatively, two individual laser diodes are used to provide the two independent laser sources.

The independent laser 104,106 will be moved in x, y, and z dimensions to deliver the properly focussed laser beam to the desired welding location. Although several methods may be used to independently deliver two separate laser beams, in this preferred embodiment, two small, separate x, y, z-positioning systems 110,112 are used. Each of the two independent lasers 104,106 are coupled to the positioning systems 110,112, thereby, allowing each laser 104,106 to be accurately positioned and assure the formation of the micro-spot welds in the desired locations based upon the vision system 30 feedback and system set up inspection. For difficult alignment accuracy specifications the two welding laser source x, y, z positioning systems 110,112 may use linear motor drives for x and y motion, and a stepper motor drive for z-motion.

For the most severe alignment and welding requirements, the two x, y, z drives would preferably be nano-positioning systems similar to the one used in the fiber alignment module 22. Such a drive would use a piezoelectric driver, or other means, to deliver weld locations with sub-micrometer to less than 10 nanometers position control. The nano-positioning drives would provide three to six degrees of motion control in the positioning of the laser spot weld. Other methods to deliver two independently controlled welding laser beams include optical methods where a beam splitter, DC-motor-driven mirrors, lenses, and other possible optics are used to independently guide the laser beams, and other mechanical methods where only two degrees of freedom of motion are used.

In an optional configuration, the two laser systems may be mounted on the positioning systems of the surface of the assembly area in the general areas indicated at 200 and 201 (FIG. 1). Here the welding laser output location is independent of gantry 62 variations.

The welding laser is fired under computer 24 control, metalurgically bonding the fiber 14 in place. If the fiber alignment was disturbed slightly during the welding operation, it may be necessary to fire the laser one or more times at different points along the periphery of the micro-fixture in an effort to ‘laser-hammer’ the alignment back into the optimized location.

Referring to FIG. 1, the system 10 further may include one of several optional fiber bonding sub-systems, schematically shown at 114, which include metal soldering, glass soldering, or polymer adhesive techniques. For a metal or glass soldering application, the process would be similar to the welding operation. The pick and place head 60 would deposit one or more metal or glass solder preforms to the proper location, and a heat source would be delivered to the preform region to cause melting and solidification after the heat source is removed.

To assure good bonding to the metal or glass solder, it is necessary for the fiber manufacturer to have previously formed a metal or glass solder wettable surface on the circumferential surface of the fiber 14, either on the organic polymer buffer coating, or on the surface of the optical fiber cladding.

Prior to soldering, the pick and place tool head 60 moves to an input feeder and picks a solder preform and places it in the proper location on, or abutting first fiber end 12, and the desired surfaces of module 16. A prior pick and place operation may have been used to place a solder preform on the proper module location, over which the first fiber end 12 will be moved, or the solder may have been applied in a prior module assembly operation away from system 10.

In most instances it is desirable to accomplish the metal or glass soldering without using any form of additive or flux. Thus the volume surrounding the location where the first fiber end 12 will be joined to module 16 is filled with an inert gas, such as nitrogen or argon, or a nonflammable forming gas, such as 95% nitrogen-5% hydrogen (Shown schematically in FIG. 1). The gas may be supplied locally by adjusting gas flow from a fixed delivery port, or the top of system 10 could be enclosed, containing the desired gas atmosphere. After the solder is placed, the curing system 38, or another heat source is used to melt the solder, bonding the fiber to the module. If a glass solder is used, it is likely that the controlled atmosphere could be avoided, allowing the normal factory assembly area ambient atmosphere to be used.

Metal solder becomes quite fluid after melting, so it is likely that only one preform will be required in common applications. Glass solder preforms have a higher viscosity when heated well above their softening points, so extensive glass flow cannot be expected. This may require the use of two or more glass solder preforms. Since the area to which the heat is delivered may be well over one square millimeter, the accuracy of the heat source does not need to be as high as with welding.

The system 10 further includes an optional liquid polymer dispenser system 34 and curing system 38, also controlled by the computer 24. The curing system 38 includes a heat source 37. The polymer dispensing system 34 is preferably a precisely controlled dispensing needle, which is moved into location by the computer 24 as guided by information from the camera 30. Due to the fluidity of the liquid polymer, the dispenser needle does not need to be positioned as accurately as the previously described laser welding source after alignment of fiber end 12 with alignment module 22, dispenser 34 deposits a precisely controlled volume of rapid cure liquid polymer 36 onto the first end 12 of the optical fiber 14 and the surfaces to which fiber end 12 is to be bonded. These surfaces may include the output facet of a laser diode, the output port of a VCSEL, the surface of the substrate to which the laser diode is bonded, the sidewall of the module housing, and the bore of an access hole through the module housing sidewall.

After dispensing, the liquid polymer, typically an epoxy, acrylate, urethane, silicone, or copolymer system, is cured. In this preferred embodiment, the polymer will be partially or fully cured due to the delivery of the desired radiation from the curing source 37 of the curing system 38. The curing source 37 can be ultraviolet radiation, but infrared or visible light radiation is not uncommon. Any type of radiation or heat source as known to one skilled in the art is within the contemplation of this invention. Since infrared radiation causes thermal heating, care must be taken not to overheat sensitive components. The curing radiation power, intensity, and duration may be under computer 24 control. It is common to need to bake the module in a batch process to achieve final polymer cure. This would be performed away from system 10.

The polymer must cure to a desired refractive index, must have very low curing shrinkage and subsequent application environment shrinkage, must show very low volatility during cure and in the subsequent application environment, and must have thermomechanical properties that will allow maintenance of the precise alignment throughout the planned operational lifetime.

Referring to FIGS. 1 and 3, the fiber indexer 52 for guiding the first end 12 of the optical fiber 14 toward the first optical module 16 includes a computer 24 controlled linear indexing mechanism within fiber indexer 52 to move the fiber end 12 towards the alignment module 22, and a fixed coarse alignment plate 90 which will typically include a tooling plate with precision grooving, or a “V-block.” The force needed for the linear movement of the fiber may be independently provided by the indexer 52 by allowing the indexer 52 to unreel fiber from the fiber spool 39. Alternatively, the indexer may provide lower indexer power, achieving the linear indexing by synchronizing this linear motion with the motor 40 driven fiber spool 39.

The first fiber end 12 exits the indexer V-block and sequentially passes through a series of process stations where V-blocks may also be used to keep the fiber end 12 in coarse alignment with the alignment module 22 during possible operations of fiber cleaning, fiber cutting, secondary fiber cleaning, and fiber end 12 shaping.

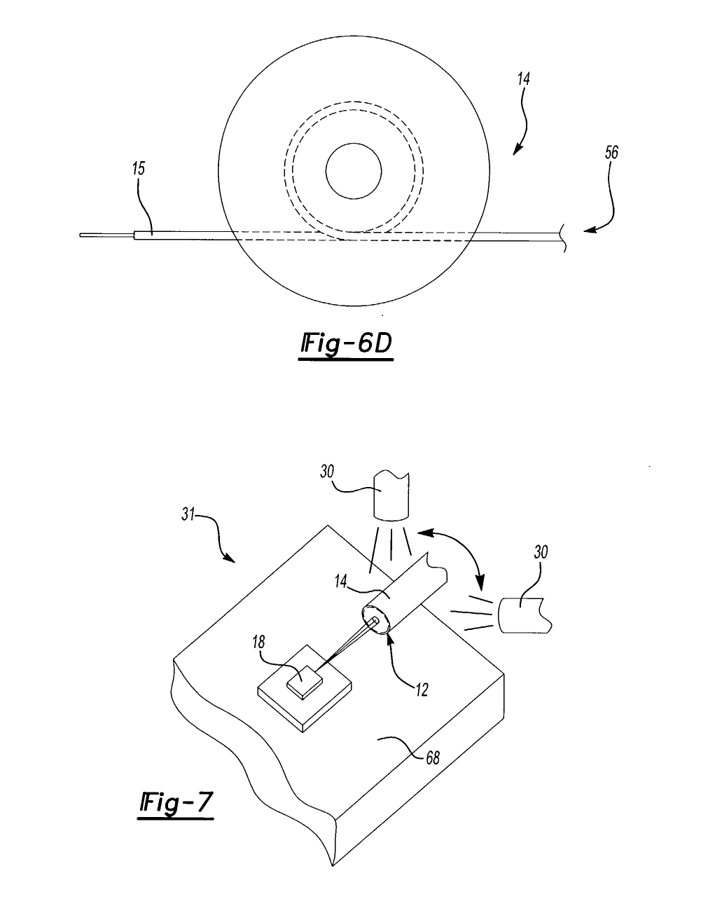

Referring to FIGS. 1 and 6A-D, before cutting the fiber, it may be desirable to remove the organic buffer coating 13 on the fiber 14 in the intended cut region using fiber cleaning station 55 (FIG. 6A). This cleaning may prevent organic buffer material 13 from contaminating the face of fiber end 12 during the cutting process and will expose the fiber surface for subsequent bonding with an organic adhesive, glass solder or metal solder. Fiber cleaning station 55 includes a solvent-based fiber buffer coat stripper station 114 followed by a cleaning plasma 116 formed by an electric arc, similar to solvent and arc plasma cleaning used in a fiber fusion splicer. In some cases the fiber cleaning station 55 may only include the arc plasma cleaner 116.

Alternatively, the fiber cleaning station 55 may use a laser alone, or in combination with the solvent cleaner or the arc plasma cleaner, to remove the organic buffer coating. The type of laser selected will be optimal for ablation of the organic buffer coating, and this laser will preferably possess a wavelength in the ultraviolet range, typically possessing a wavelength of less than 400 nanometers and more than 100 nanometers.

After this optional buffer coating removal operation, the cleaned fiber region is indexed to the fiber cutter 54 (FIG. 6B) through the action of the fiber indexer 52, or through the action of another indexing mechanism located in the path of the indexing fiber. The fiber cutter 54 is preferably controlled by the computer 24, but could also be operated manually. The fiber cutter will be capable of providing a fiber end face 205 which is suitable for bonding to the laser diode module with no end face polishing. It is less critical for the fiber end 206 to be of such a quality, but it is also intended for the quality of fiber end 206 to be of high quality such that end face polishing is not required.

Referring to FIG. 6C, optionally, it will be desirable to have optional second arc plasma cleaner 118 to clean the face of fiber end 12 after the cutting operation. This second arc plasma may optionally also be used to shape the end of the optical fiber by partially or completely fusing the fiber end 12. This shaping of fiber end 12 can form a rounded shape on fiber end 12, or the core of fiber end 12, potentially aiding in the subsequent alignment process due to the lens effect the rounded core or end provides.

After all the possible steps of cleaning, cutting, cleaning, and shaping of fiber end 12, fiber end 12 is indexed into the fiber coiling mechanism 56 (FIG. 6D). The indexer or gripper of fiber coiling mechanism 56 then grips the fiber leaving a desired free length of fiber 14 extending beyond the coiling mechanism gripper. The desired length of fiber is then coiled without twisting the fiber about the fiber axis. The coiling mechanism may cause unreeling of fiber from fiber spool 39, or the coiling motion may be synchronized with unreeling of fiber spool 39 by motor 40 to minimize stress on the fiber 14. The pick and place head 60 may then press a clip on to coil of optical fiber 14 to prevent uncoiling. The coiling mechanism then indexes the first fiber end 12 or fiber 14 into the fiber alignment module 22. At this point, the fiber alignment module 22 gripper seizes the fiber end 12. After the fiber end 12 is properly positioned in coarse alignment in the alignment module 22, the alignment module gripper moves the fiber end 12 through the programmed motion sequence on axes x, y, and z, and by rotating fiber end 12 about each of the x, y, and z axes. Referring to FIG. 6E, a vision system 31 will monitor this precision alignment sequence to provide optimum feedback to the alignment module 22 to assist in initial coarse alignment. The vision system 31 may use two optional vision modules 30 viewing fiber end 12 orthogonally. This is accomplished using a vision system sensitive to the wavelengths of the laser diode, the image system can rapidly help the mechanical motion find the laser beam. The vision elements can view the fiber and fiber core (if not metalized) and also see the laser light to assist alignment. The computer 24 controlled motion algorithm will run until a satisfactory alignment or the best possible alignment is achieved, as measured by the detector 42 at the second fiber end 44.

The optical fiber 14 is coiled about the spool 39 which is driven by a motor 40, controlled by the computer 24. The second optical module 42 mounted adjacent the second end of the optical fiber 14. The second optical module 42 preferably comprises the laser receiver 48 mounted on the circuit board 50. The second end 44 of the optical fiber 14 is previously aligned with the receiver 48 (or a lens for receiver 48) and secured to the second optical module 42. The output of receiver 48 is sent to the computer 24.

The fiber guide 52 guides the first end 12 of the optical fiber 14 toward the first optical module 16. The fiber guide 52 includes the optical fiber cutter 54. The fiber guide 52 may be a “V-block.” The fiber cutter 54 is preferably controlled by the computer 24, but could also be operated manually. The coating 13 on the fiber 14 is preferably removed at the cleaning station 55, using processes like those used in a fiber fusion splicer before fiber cutting at the fiber cutter 54. The fiber coiling mechanism 56 may be positioned between the fiber cutter 54 and the first optical module 16, to automatically coil the approximately one to five meters of optical fiber 14 attached to the first optical module 16. The optical fiber end face cleaning module 58 (such as, or similar to, a cleaning arc as is used in a fusion splicer) is also positioned adjacent the fiber cutter 54.

The pick and place tool head 60 is preferably mounted on a gantry cross beam 62 above the optical module 16. The pick and place tool head 60 utilizes a vacuum nozzle 61 to selectively pick optical modules from module input area 64 and place them in assembly area 65 and subsequently to move the completed optical module from assembly area 65 to module output area 66. Assembly area 65 includes a powered load board preferably mounted on an optional intermediate alignment module 68, which includes motors for moving the assembly area 65 in one to three linear axes and for rotating and tilting assembly area 65 about one to three axes.

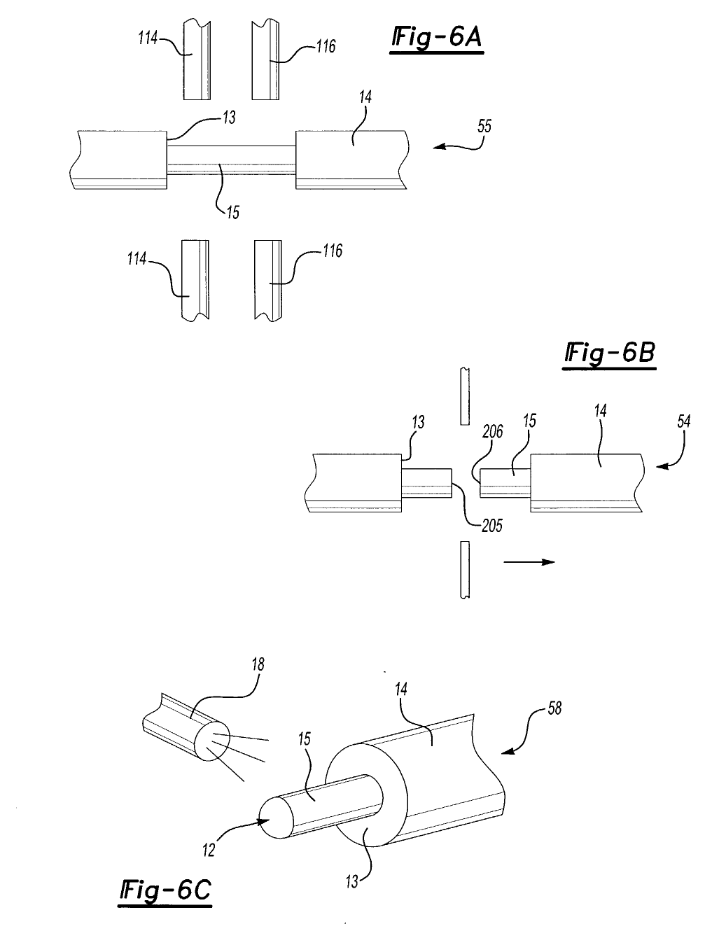

Referring to the block diagram of FIG. 5, in operation, the computer 24 controls the pick and place head 60 to move the first optical module 16 from module input area 64 to assembly area 65. The fiber is then indexed and the end 12 prepared. The computer 24 then controls the motor 40 to unspool optical fiber 14, thus moving the first end 12 of the optical fiber 14, as guided by fiber guide 52, generally toward the first optical module 16 while the computer 24 monitors the progress of the first end 12 toward the first optical module 16 by receiving visual information from camera 30. The computer 24 stops the first end 12 at the proper distance (preferably approximately less than or equal to 15 microns) from the laser diode 18 or lens for laser diode 18 of the first optical module 16 based upon the visual feedback from the camera 30. The computer 24 then controls the intermediate alignment module 68 to translate and rotate the assembly area 65 while monitoring the transmission of the optical signal between the first optical module 16 and second optical module 44 via the optical fiber 14 by monitoring the electrical signal from the laser receiver (in this example, the second optical module 44). This may be done to provide a coarse alignment of the first optical module 16 with the first end 12 of the optical fiber 14. This motion by intermediate alignment module 68 may also provide the final precision alignment by moving the module which is mounted on the powered load board mounted on intermediate alignment module 68. The would eliminate the need for final precision alignment of the first fiber end 12 with the laser diode 18 or lens for laser diode 18 of the first optical module 16. Alternatively movement of the module on intermediate alignment module 18 could be conducted to allow the detection of the first laser signal while the fiber end 12 is in the final stages of indexing towards the alignment module 68. Subsequently the final alignment could be conducted by the fiber alignment/movement system 22.

The first and second optical modules 16, 44 are powered and the computer 24 monitors the transmission of the optical signal (laser) between the first optical module 16 and second optical module 44 via the optical fiber 14 by monitoring the electrical signal from the laser receiver (in this example, the second optical module 44).

While monitoring the transmission of the optical signal through the optical fiber 14, the computer 24 controls fiber alignment/movement system 22 to move the first end 12 of the optical fiber 14. By monitoring the output from receiver 48, the computer 24 determines the optimal position of the first end 12 where the output from receiver 48 is maximized. Keeping the first end 12 at this optimal position, the computer 24 then controls the polymer dispensing system 34 to dispense a predetermined amount of rapid cure polymer onto the first end 12 of optical fiber 14. The first end 12 is then secured to the board 20 at the optimal position relative to the laser transmitter 18 (or its lens) by the curing system 38.

In one embodiment, the polymer 36 is dispensed after the first end 12 of the optical fiber 14 is determined to be in its optimal position. Alternatively, the polymer may be dispensed prior to movement of the first end 12, in which case the movement of the optical fiber 14 assists in spreading the polymer 36. Then, when the first end 12 is determined to be in the optimal position, the curing system 38 is switched on by computer 24 to secure the first end 12 in the optimal position.

The computer 24 signals the fiber cutter system 54 to remove the coating on the optical fiber 14 using the solvent cleaner and cleaning arc 55 and to cut the optical fiber 14. End face cleaning module 58 cleans the cut end of the optical fiber 14 in preparation for joining to the next optical module. The pick and place head 60 then moves the first optical module 16, with the coiled length of optical fiber 14, to assembled module output area 66. Cutting may take place before or after the alignment and attachment of the optical fiber 14 to the first optical module 16.

The entire aforementioned process is then repeated for additional optical modules.

Although the above system and method have been described with respect to the first optical module 16 including a laser diode 18 and the second optical module 42 including a laser receiver 48, the present invention is equally applicable to the first optical module 16 including a laser receiver and a second optical module 42 including a laser diode. In either case, the computer 24 would power the laser transmitter 18 while simultaneously monitoring the signal received by a laser receiver to determine the proper position of the first end 12 of the optical fiber 14.

In addition to the above attachment process, optional mechanical reinforcement may include filling the volume between the fiber surface and the package ferrule bore with dispensed resin and in situ curing, or the ferrule could be similarly filled and reflowed with solder. A mechanical clip could be pick-and-placed over the fiber and resin bonded, soldered or laser welded to the circuit board 20. Optionally, an additional, secondary dispensing of resin and a secondary curing could add strength to the fiber-to-component join, if package specifications and thermomechanical stresses permit.

In an alternative attachment process, solder could be used to attach the first end 12 of the optical fiber 14 in alignment with the laser transmitter 18 (or laser receiver). In this method, the substrate surface immediately adjacent to the laser diode 18, the photo diode or lens is comprised of a defined solder wettable pad area. The glass surface of the optical fiber 14, or the surface of the insulating/reinforcing sheath of the fiber, is metalized so as to be solderable. (Alternatively, it is also possible that a compression seal of a solid solder preform against an unwettable fiber surface would provide desired results.) The first end 12 of the optical fiber 14 is then soldered in alignment with the laser transmitter 18 (or receiver, as is the case) using a heat source directed and controlled by the computer 24. The pick and place head 60 delivers a solder preform to the interface region between the first end 12 of the optical fiber 14 and a laser transmitter 18 (or receiver).Alternatively, the heat source can keep the solder molten while alignment module 22 conducts final alignment optimization.

The preform could be pre-fluxed, or the soldering could be accomplished under a controlled atmosphere to eliminate the need for a flux. This could be accomplished by simply enclosing the entire top of this system to allow the top to be filled with an inert gas (nitrogen, argon, etc.). Alternatively, the immediate volume about the intended soldering region could be filled with flowing inert gas, with a nitrogen/hydrogen forming gas or hydrogen (which would require special safety modifications). Solder performs would also be pick and placed for soldering the fiber in the ferrule bore. It is also possible to use a solder material that would not need a flux and which will solder effectively in air, such as gold-tin, indium-gold, amalgams of various chemistries, etc.

Although shown horizontal, the first optical module 16 may be positioned in any desired orientation, ranging from horizontal to vertical through computer 24 controlled movement of the optional intermediate alignment module system supporting the work area or using a reconfigurable work station feature. This feature could be provided by the intermediate alignment module 68. This may be desirable in order to control the flow characteristics of the liquid polymer 36 or solder.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for connecting a first end of an optical fiber to a laser module including the steps of:
a. positioning a laser transmitter generally adjacent one of a first end and a second end of the optical fiber;
b. positioning a laser receiver at the other of the first end and the second end of the optical fiber;
c. transmitting an optical signal from the laser transmitter through the optical fiber and receiving the optical signal at the laser receiver;
d. controlling movement with a computer of the first end of the optical fiber relative to one of the laser transmitter and the laser receiver during said step c);
e. monitoring the optical signal received by the laser receiver during said step d) with a light sensing system and the computer; and
f. determining an optimal position of the first end of the optical fiber based upon said step e).

2. The method of claim 1 further including the steps of:
Controlling movement of the first end of the optical fiber with the computer; and
Moving the first end of the optical fiber to the optimal position.

3. The method of claim 1 further including the step of securing the first end of the optical fiber at the optimal position.

4. The method of claim 3 further including the step of dispensing a liquid polymer on the first end to secure the first end at the optimal position.

5. The method of claim 4 further including the step of controlling the dispensing of the polymer with the computer.

6. The method of claim 5 further including the step of controlling with a computer a rapid cure system to cure the polymer to secure the first end at the optimal position.

7. The method of claim 3 wherein said step d) further includes the step of monitoring movement of the first end of the optical fiber relative to the laser transmitter.

8. A system for connecting a first end of an optical fiber to a first optical module including:
a. a second optical module generally adjacent a second end of the optical fiber, one of the first and second modules generating an electrical signal based upon an optical signal transferred between the first and second modules through the optical fiber; and
b. a computer receiving the electrical signal and controlling movement of the first end of the optical fiber to a first position relative to the first optical module based upon the electrical signal.

9. The system of claim 8 wherein the first optical module includes an optical transmitter and the second optical module is an optical receiver.

10. The system of claim 8 wherein the first optical module is an optical receiver and the second optical module is an optical transmitter.

11. The system of claim 8 further including means for attaching the first end of the optical fiber to the first optical module in the first position.

12. The system of claim 8 further including a spool about which the optical fiber is coiled.

13. The system of claim 12 wherein the computer controls rotation of the spool to sequentially unspool a desired length of the optical fiber for attachment to each of a plurality of the first optical module.

14. The system of claim 8 further including alignment means for moving the first end relative to the first optical module, the computer controlling the alignment means.

15. The system of claim 14 further including at least one positioning system controlled by the computer for moving the first end relative to the first optical module.

16. The system of claim 14, wherein said positioning system is movable in at least 3 axes.

17. The system of claim 15 further including a camera connected to the computer, the computer controlling movement of the first end of the optical fiber based upon visual information indicating the position of the first end of the optical fiber.

18. A system for connecting a first end of an optical fiber to a laser transmitter including:
a. a laser receiver optically coupled to a second end of the optical fiber and generating an electrical signal based upon an optical signal received by the laser receiver via the optical fiber; and
b. a computer controlling movement of the first end of the optical fiber relative to the laser transmitter based upon the electrical signal from the laser receiver.

19. The system of claim 17 wherein the computer controls movement of the first end of the optical fiber to an optimal position based upon the electrical signal from the laser receiver.

20. The system of claim 18 further including a liquid polymer dispensing system for selectively securing the first end at the optimal position adjacent the laser transmitter.

21. The system of claim 19 further including a camera sending visual information to the computer indicative of the position of the first end relative to the laser transmitter.

22. The system of claim 18, further including an atmosphere control system for controlling atmospheric conditions within the system.

23. The system of claim 18, wherein said optical fiber is coiled on a spool.

24. The system of claim 18, further including a cutting mechanism to cut said optical fiber into desired lengths.

25. The system of claim 18, further including a coiling mechanism for coiling said optical fiber.

26. The system of claim 18, wherein said laser transmitter is aligned relative to said electrical signal.
